(19) United States
(12) Patent Application Publication
(10) Pub. No.: US 2024/0051060 A1
(43) Pub. Date: Feb. 15, 2024

(54) METHOD FOR JOINING AN ALUMINUM COMPONENT TO A STEEL COMPONENT USING A WELDED RIVET

(71) Applicant: GM GLOBAL TECHNOLOGY OPERATIONS LLC, Detroit, MI (US)

(72) Inventors: Blair E. CARLSON, Ann Arbor, MI (US); Hassan Ghassemi-Armaki, Northville, MI (US)

(21) Appl. No.: 17/887,956

(22) Filed: Aug. 15, 2022

(51) Int. Cl. B23K 11/00

(52) U.S. Cl. CPC B23K 11/0066

(57) ABSTRACT

A method for welding includes arranging an aluminum component including a cavity adjacent to a steel component; and using a weld tool including an electrode and arms configured to engage a rivet, arranging the rivet in the cavity in contact with the steel component. A volume of a portion of the rivet located above of the cavity is approximately equal to an annular volume between a stem of the rivet and an inner surface of the cavity. The method includes applying pressure on the rivet using the electrode; and applying current to the electrode to weld the rivet in the cavity.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to joining of two components made of dissimilar materials together, and more particularly to welding an aluminum component to a steel component using a rivet.

In some applications, an aluminum (Al) component such as an (Al) body side outer (BSO) is joined to a steel component such as a body in white (BIW) support structure using structural adhesive. This approach requires the Al BSO to be held in position through the paint shop to ensure dimensional geometry during curing of the structural adhesive. Because the body side inner may include Al—Si coated press hardened steel and/or thick advanced high strength steel (AHSS) (>980 MPa), conventional riveting processes do not work. Rivet-welding or rivet-friction approaches cause protrusions above the Al BSO that are unacceptable in some applications. For example, the protrusions may be located in a mounting area such as a door flange mounting area. The protrusions obstruct assembly of a door seal.

### SUMMARY

A method for welding includes arranging an aluminum component including a cavity adjacent to a steel component; and using a weld tool including an electrode and arms configured to engage a rivet, arranging the rivet in the cavity in contact with the steel component. A volume of a portion of the rivet located above of the cavity is approximately equal to an annular volume between a stem of the rivet and an inner surface of the cavity. The method includes applying pressure on the rivet using the electrode; and applying current to the electrode to weld the rivet in the cavity.

In other features, the method includes, after a first predetermined period after applying current to the electrode, retracting the arms of the weld tool; and continuing to apply current to the electrode for a second predetermined period after the first predetermined period.

In other features, the first predetermined period comprises 1/10 to ⅕ of a total period including the first predetermined period and the second predetermined period. The method includes, after applying pressure on the rivet using the electrode and before applying current, retracting the arms of the weld tool. The rivet includes a coating on a head of the rivet in contact with the electrode of the weld tool, wherein the coating reduces a resistance between the electrode and the head of the rivet. A resistance between the electrode and the rivet is less than a resistance between the rivet and the steel component.

In other features, the rivet is made of carbon coated steel with an ultimate tensile strength in a predetermined range between 1000 MPa and 1500 MPa. The aluminum component comprises an Al body side outer (BSO) and the steel component comprises a body in white (BIW) support structure. The steel component comprises a material selected from a group consisting of aluminum-silicon (Al—Si) coated press hardened steel and advanced high strength steel (AHSS) having a tensile strength greater than 980 MPa.

In other features, a head of the rivet has a frustoconical shape and the stem is cylindrical. Sides of the head of the rivet form an angle in a range from 30° to 60° relative to sides of the stem. An end of the electrode that contacts the rivet is larger than a diameter of a head of the rivet.

A method for welding comprises arranging an aluminum component including a cavity adjacent to a steel component; and using a weld tool including an electrode and arms configured to engage a head of a rivet, arranging the rivet in the cavity in contact with the steel component. The head of the rivet has a frustoconical shape and a stem of the rivet has a cylindrical shape. Sides of the head of the rivet form an angle in a range from 30° to 60° relative to sides of the stem. A volume of the rivet is approximately equal to a volume in the cavity. A head of the rivet in contact with the electrode of the weld tool includes a coating to reduce a resistance between the electrode and the head of the rivet. The method includes applying pressure on the rivet using the electrode; and applying current to the electrode to weld the rivet in the cavity.

In other features, after a first predetermined period after applying current to the electrode, the method includes retracting the arms of the weld tool; and continuing to apply current to the electrode for a second predetermined period after the first predetermined period.

In other features, the first predetermined period comprises 1/10 to ⅕ of a total period including the first predetermined period and the second predetermined period.

In other features, the method includes applying pressure on the rivet using the electrode and before applying current, retracting the arms of the weld tool. A resistance between the electrode and the rivet is less than a resistance between the rivet and the steel component. The rivet is made of carbon coated steel with an ultimate tensile strength in a predetermined range between 1000 MPa and 1500 MPa. The aluminum component comprises an Al body side outer (BSO) and the steel component comprises a body in white (BIW) support structure. The steel component comprises a material selected from a group consisting of an aluminum-silicon (Al—Si) coated press hardened steel and an advanced high strength steel (AHSS) having a tensile strength greater than 980 MPa. An end of the electrode that contacts the rivet is larger than a diameter of the head of the rivet.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross-sectional view of an example of the rivet according to the present disclosure;

FIG. 2 is a side cross-sectional view of an example of the rivet arranged in a cavity in an aluminum component arranged adjacent to a steel component before welding according to the present disclosure;

FIG. 3 is a side cross-sectional view of an example of the rivet arranged in a cavity after welding according to the present disclosure;

FIG. 4 is a side cross-sectional view of a welding tool holding the rivet according to the present disclosure; and

FIGS. 5 and 6 are flowcharts of methods for joining the aluminum component and the structural component using a welded rivet according to the present disclosure.

In the drawings, reference numbers may be reused to identify similar and/or identical elements.

### DETAILED DESCRIPTION

While the present disclosure will be described in the context of joining an aluminum component to a steel component of a vehicle using a welded rivet, the present disclosure can be used in non-vehicle applications.

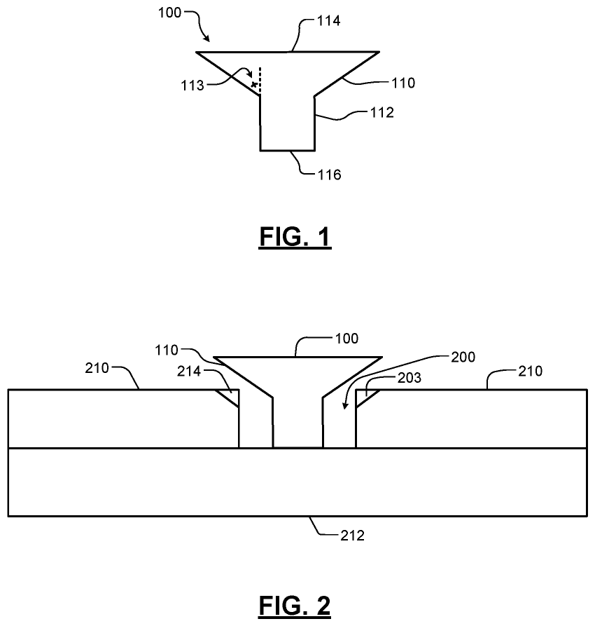

Referring now to FIG. 1, a rivet 100 includes a head 110 and a stem 112 extending from the head 110. In some examples, the head has a conical frustum shape and the stem has a cylindrical shape. In some examples, an angle 113 between opposite sides of the head 110 and a line parallel to sides of the stem 112 is in a predetermined range between 30° and 60°.

In some examples, a top surface of the head 110 includes with a resistance-reducing coating 114 to reduce a resistance between the electrode of the weld tool and the head 110 of the rivet 100. In some examples, the resistance of the electrode to the rivet (E/R) is less than the resistance of the rivet to the steel component (R/S). As a result, there is less heat generation at the head 110 as compared to the bottom surface of stem 112 of the rivet 100 (where melting is desired).

In some examples, the rivet 100 is made of low carbon coated steel with ultimate tensile strength in a predetermined range between 1000 MPa and 1500 MPa.

In some examples, the diameter of the stem 112 of the rivet 100 is sized to provide sufficient surface area to generate enough heat to melt the bottom surface of the stem 112 of the rivet 100 and to flow the melt material in the volume between the rivet 100 and sides of a cavity in the aluminum component. In some examples, surface resistivity is correlated to interlayer diffusion and the resistance spot welding (RSW) process through image processing of the surface of the steel component after welding. In some examples, a welding schedule generates heat at the interface of stem of the rivet and the steel component more than heat between head of the rivet and the bottom of the electrode.

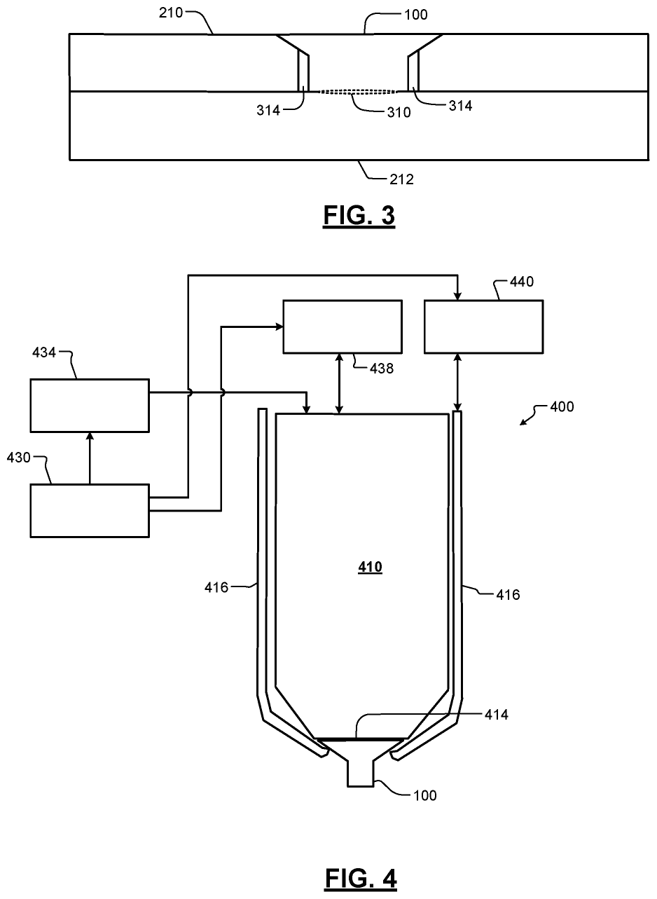

Referring now to FIGS. 2 and 3, the rivet 100 is arranged in a cavity 200 in an aluminum component 210 arranged adjacent to a steel component 212. In some examples, the aluminum component 210 comprises an aluminum panel and the steel component 212 comprises a support structure. As will be described further below, the volume of the rivet 100 above the aluminum component 210 is equal to an annular volume between the stem 112 of the rivet 100 and the cavity 200 in the aluminum component 210. Stated differently, the volume of the rivet is equal to the volume in the cavity in the aluminum component. In some examples, a chamfer of the head 110 of the rivet 100 induces flow of Al around the cavity 200 to create sufficient overlap/mechanical bonding as a process joint.

In FIG. 2, the volume of the rivet 100 and the volume of the cavity 200 are designed to be approximately equal such that the rivet 100 is flush with an outer surface of the aluminum component 210 after welding. In some examples, the head 110 of the rivet 100 fills an annular volume in the cavity 200 surrounding the stem 112. In other words, the rivet 100 completely fills the annular volume after welding without protrusions or a low spots. As used herein, approximately means that the volume of the rivet 100 and the volume of the cavity are within 2%, 3%, 4%, or 5% of one another when taking into consideration the displaced aluminum such as at 214.

In some examples, the aluminum component 210 corresponds to an aluminum (Al) body side outer (BSO) and the steel component 212 corresponds to a body in white (BIVV) support structure. In some examples, the steel component 212 includes Al—Si coated press hardened steel and/or thick advanced high strength steel (AHSS) (>980 MPa).

In FIG. 3, the rivet 100 is shown after welding. As the rivet 100 is heated, the rivet 100 and the steel component 212 begin to melt and a puddle of melted steel 310 forms. A combination of melted steel 300 and displaced aluminum 314 fill the annular volume between the rivet 100 and the cavity 200 so that the cavity 200 is filled, and the rivet 100 sits flush with the aluminum component 210.

Referring now to FIG. 4, a weld tool 400 includes an electrode 410 and arms 416 to engage and release the rivet 100. A weld controller 430 is configured to cause a power supply 434 to supply a predetermined weld current to the electrode 410 based on a weld schedule defining fixed or variable current levels and/or durations. The weld controller 430 is configured to control an actuator 438 to cause the electrode 410 to apply pressure on the rivet 100 against the steel component 212. The weld controller 430 is configured to control an arm actuator 440 to extend and retract the arms 416 that engage the head 110 of the rivet 100.

In some examples, a base portion of the electrode 410 in contact with the head 110 of the rivet 100 has a diameter that is greater than or equal to a diameter the rivet head 101. As a result, the rivet 100 is not deformed when pressure and welding current are applied. The arms 416 are designed to hold rivet 100 in place during welding.

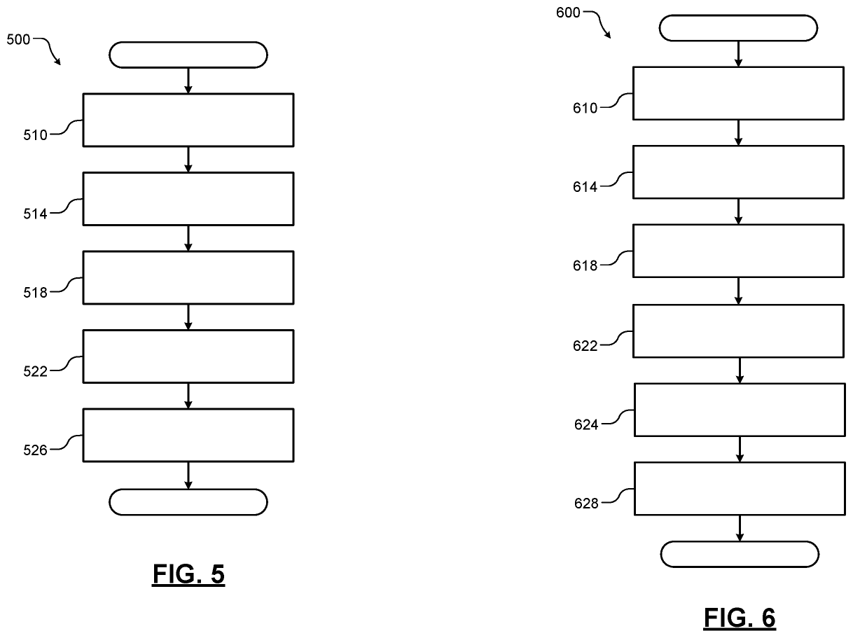

Referring now to FIGS. 5 and 6, flowcharts of methods 500 and 600 for welding the rivet 100 are shown. In FIG. 5, the cavity 200 is formed in the aluminum component 210 at 510 and the aluminum component 210 is arranged adjacent to the steel component 212. At 514, the weld tool 400 arranges the rivet 100 in the cavity against the steel component 212. At 518, the weld tool 400 applies a predetermined force to the rivet 100 against the steel component 212. At 522, the arms 416 are retracted to release the rivet 100. At 526, the weld tool 400 applies welding current based on the weld schedule to the rivet 100.

The combination of the pressure and weld current causes the rivet 100 and the steel component 212 to form a weld puddle. The rivet 100 is welded to the steel component 212. The pressure on the rivet causes part of the aluminum outer layer 201 to be displaced into the cavity 200. After welding, the rivet 100 fills the cavity 200 and the head of the rivet is flush with an outer surface of the aluminum panel.

In FIG. 6, the cavity 200 is formed in the aluminum component 210 at 610 and the aluminum component 210 is arranged adjacent to the steel component 212. At 614, the weld tool 400 arranges the rivet 100 in the cavity 200 against the steel component 212. At 618, the weld tool 400 applies a predetermined force to the rivet 100 against the steel component 212. At 622, the weld tool applies weld current. After a first predetermined period, the arms are retracted. In some examples, the first predetermined period comprises 1/10 and ⅕ of the total welding time. At 624, the arms 416 are retracted to release the rivet 100. At 628, the weld tool continues to apply weld current until a second predetermined period is up (corresponding to the rest of the weld period).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A method for welding comprising:
arranging an aluminum component including a cavity adjacent to a steel component;
using a weld tool including an electrode and arms configured to engage a rivet, arranging the rivet in the cavity in contact with the steel component,
wherein a volume of a portion of the rivet located above of the cavity is approximately equal to an annular volume between a stem of the rivet and an inner surface of the cavity;
applying pressure on the rivet using the electrode; and
applying current to the electrode to weld the rivet in the cavity.

2. The method of claim 1, further comprising:
after a first predetermined period after applying current to the electrode, retracting the arms of the weld tool; and
continuing to apply current to the electrode for a second predetermined period after the first predetermined period.

3. The method of claim 2, wherein the first predetermined period comprises 1/10 to ⅕ of a total period including the first predetermined period and the second predetermined period.

4. The method of claim 1, further comprising after applying pressure on the rivet using the electrode and before applying current, retracting the arms of the weld tool.

5. The method of claim 1, wherein the rivet includes a coating on a head of the rivet in contact with the electrode of the weld tool, wherein the coating reduces a resistance between the electrode and the head of the rivet.

6. The method of claim 1, wherein a resistance between the electrode and the rivet is less than a resistance between the rivet and the steel component.

7. The method of claim 1, wherein the rivet is made of carbon coated steel with an ultimate tensile strength in a predetermined range between 1000 MPa and 1500 MPa.

8. The method of claim 1, wherein the aluminum component comprises an Al body side outer (BSO) and the steel component comprises a body in white (BIW) support structure.

9. The method of claim 1, wherein the steel component comprises a material selected from a group consisting of aluminum-silicon (Al—Si) coated press hardened steel and advanced high strength steel (AHSS) having a tensile strength greater than 980 MPa.

10. The method of claim 1, wherein:
a head of the rivet has a frustoconical shape and the stem is cylindrical; and
sides of the head of the rivet form an angle in a range from 30° to 60° relative to sides of the stem.

11. The method of claim 1, wherein an end of the electrode that contacts the rivet is larger than a diameter of a head of the rivet.

12. A method for welding comprising:
arranging an aluminum component including a cavity adjacent to a steel component;
using a weld tool including an electrode and arms configured to engage a head of a rivet, arranging the rivet in the cavity in contact with the steel component,
wherein the head of the rivet has a frustoconical shape and a stem of the rivet has a cylindrical shape,
wherein sides of the head of the rivet form an angle in a range from 30° to 60° relative to sides of the stem,
wherein a volume of the rivet is approximately equal to a volume in the cavity,
wherein a head of the rivet in contact with the electrode of the weld tool includes a coating to reduce a resistance between the electrode and the head of the rivet;
applying pressure on the rivet using the electrode; and
applying current to the electrode to weld the rivet in the cavity.

13. The method of claim 12, further comprising:
after a first predetermined period after applying current to the electrode, retracting the arms of the weld tool; and
continuing to apply current to the electrode for a second predetermined period after the first predetermined period.

14. The method of claim 13, wherein the first predetermined period comprises 1/10 to ⅕ of a total period including the first predetermined period and the second predetermined period.

15. The method of claim 12, further comprising after applying pressure on the rivet using the electrode and before applying current, retracting the arms of the weld tool.

16. The method of claim 12, wherein a resistance between the electrode and the rivet is less than a resistance between the rivet and the steel component.

17. The method of claim 12, wherein the rivet is made of carbon coated steel with an ultimate tensile strength in a predetermined range between 1000 MPa and 1500 MPa.

18. The method of claim 12, wherein the aluminum component comprises an Al body side outer (BSO) and the steel component comprises a body in white (BIW) support structure.

19. The method of claim 12, wherein the steel component comprises a material selected from a group consisting of an aluminum-silicon (Al—Si) coated press hardened steel and an advanced high strength steel (AHSS) having a tensile strength greater than 980 MPa.

20. The method of claim 12, wherein an end of the electrode that contacts the rivet is larger than a diameter of the head of the rivet.
